(19) United States
(12) Patent Application Publication
(10) Pub. No.: US 2002/0147597 A1
(43) Pub. Date: Oct. 10, 2002

(54) System and method for restocking and repricing merchandise

(76) Inventors: Daniel Patrick Connors, Wappingers Falls, NY (US); John D. Mackay, Sleepy Hollow, NY (US); Howard E. Sachar, Mount Kisco, NY (US)

Correspondence Address: MCGINN & GIBB, PLLC, 8321 OLD COURTHOUSE ROAD, SUITE 200, VIENNA, VA, 22182-3817, US

(21) Appl. No.: 09/825,879

(22) Filed: Apr. 5, 2001

(51) Int. Cl. G06F 17/60

(52) U.S. Cl. 705/1

(57) ABSTRACT

A system restocking and repricing merchandise includes a shelf label holder having an illuminating function, and a hand-held unit which remotely causes the shelf label holder to illuminate under predetermined conditions. The system may also include a host controller for directing the operation of the hand held unit and shelf label holder.

### BACKGROUND OF THE INVENTION

1. Field of the Invention

The present invention generally relates to a system and method for restocking and repricing merchandise and more particularly to a system and method for restocking and repricing merchandise which utilizes an electronic shelf control unit.

2. Description of the Related Art

Store shelves and display racks are typically organized by planograms (i.e., diagrams which pictorially display merchandise locations on store shelves). These planograms are also used to guide employees who are tasked with restocking or repricing a particular merchandise. For the most part, these are labor intensive chores involving many employees. In fact, large stores may spend as many as one hundred man-hours per week on price changes alone. Moreover, about 20-30% of this time is spent searching for the shelf on which the merchandise to be restocked or repriced is located.

The most common means for pricing merchandise is by the use of a paper shelf label. The label is typically printed by the stock/price clerk and affixed on the shelf directly underneath the merchandise. The paper label is inexpensive and provides highly visible pricing information printed thereon. However, as noted above, this method is highly labor intensive and does not aid the clerk in locating the proper shelf during repricing or restocking.

Electronic shelf tags have also been proposed. Here, the electronic tag is affixed to the shelf near the merchandise so that the price may selectively changed electronically. These tags reduce the amount of paper required and the time necessary for printing labels. However, this technology is expensive and is not currently able to provide the same information density as paper shelf labels for an affordable price. In addition, such electronic displays are relatively fragile compared to the paper label and cannot withstand “shopping cart attack” and other physical abuses like the paper label. Moreover, like paper labels, such electronic tags do not help to guide the store clerk to the correct shelf location.

### SUMMARY OF THE INVENTION

In view of the foregoing problems of the conventional methods, an object of the present invention is to provide an inexpensive and effective system and method for restocking and repricing merchandise on store shelves which helps to guide stock/price clerks to a correct shelf location.

In a preferred embodiment, the present invention includes a shelf label holder having an illuminating function and a hand-held unit which remotely causes the shelf label holder to illuminate under predetermined conditions. The inventive system may also include a host controller for storing inventory information and remotely controlling operation of the handheld unit.

In one aspect, the shelf label holder may include a shelf label having an identifying section, an illuminating section, and a shelf control unit for controlling an illumination of the illuminating section. The shelf control unit may include a port for receiving the identifying section of the shelf label and a transceiver for transmitting and receiving signals.

In another aspect, the hand held unit may include a transceiver for transmitting and receiving signals, a display device, a memory device and at least one of a bar code scanner or keypad, for inputting data into the inventive system.

In another aspect, the host controller may include a display device, a memory device for storing an information such as planogram information and an inventory database, a bar code scanner and a keypad for inputting data into the system and a transceiver for transmitting and receiving signals.

The present invention may further include a method for restocking and repricing merchandise using a system having a shelf label holder, a hand held unit and a host controller. The inventive method may include inputting planogram data into the host controller, inputting merchandise data into the hand held unit or the host controller, and remotely causing a shelf label holder to illuminate the section of the shelf label holder corresponding to a correct location for the merchandise.

In one aspect of the inventive method, the information is remotely input into the hand-held device by the host controller.

In another aspect of the inventive method, the hand-held unit includes a keypad and the information is manually input into the hand-held unit using the keypad.

With its unique and novel features and designs, the present invention provides a fast, inexpensive and accurate system and method of restocking and repricing merchandise.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 illustrates a system 100 for restocking and repricing merchandise according to the present invention;

FIG. 2 illustrates a shelf label holder 200 according to the present invention; and

FIG. 3 is a flow diagram illustrating a preferred method 300 of restocking and repricing merchandise according to the present invention.

### DETAILED DESCRIPTION OF PREFERRED EMBODIMENTS OF THE INVENTION

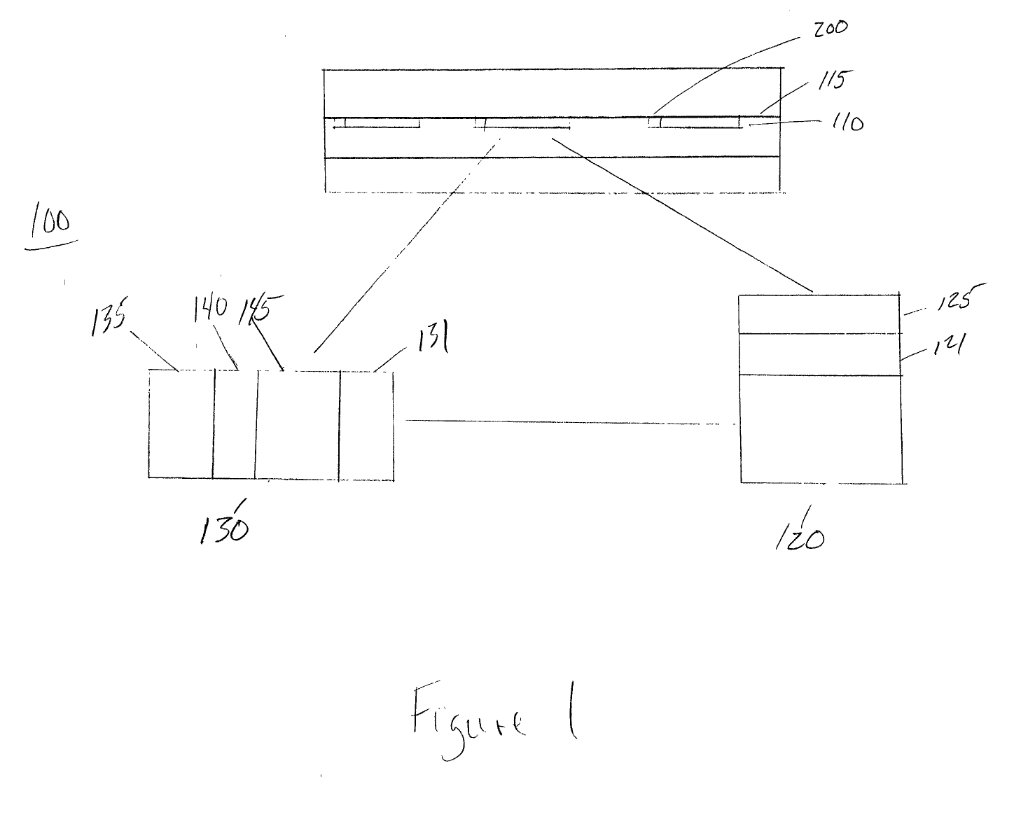

Referring now to the drawings, FIG. 1 illustrates a system 100 for restocking and repricing merchandise according to the present invention.

The inventive system 100 may include a shelf label holder 200 which is affixed on a shelf 115 (e.g., bottom of a shelf, top of a shelf, etc), a hand-held unit 130 which may be carried by the stock/price clerk, and a host controller 120 which controls the operation of the system. As explained in detail below, under a set of predetermined conditions, or at the direction of the store clerk, the shelf label holder 200 may be caused to illuminate, thereby identifying for the clerk the correct shelf and row location for a particular merchandise.

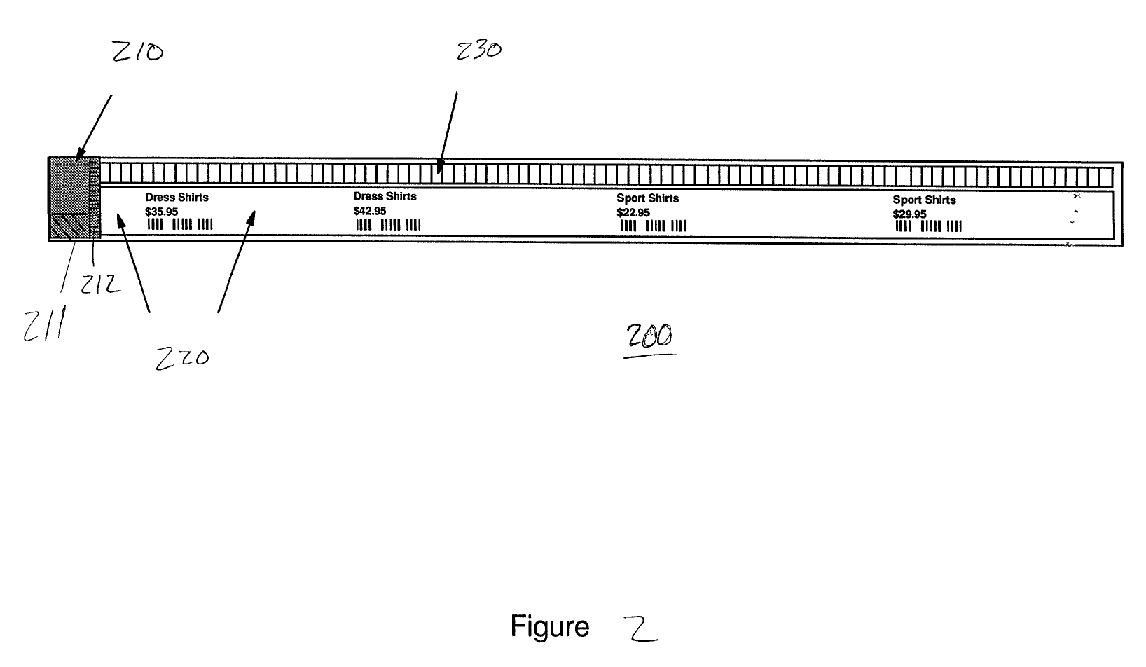

As detailed in FIG. 2, the shelf label holder 200 may include a shelf control unit 210 and an illuminating section 230 which illuminates under predetermined conditions or at the direction of the stock/price clerk in order to direct the stock/price clerk to the desired shelf. In addition, a shelf label 220 may be inserted into the shelf label holder 200 for identifying the merchandise on the shelf. Alternatively, the illuminating section 230 may be replaced by any other device for transmitting a visual or audible signal, such as, for example, a beeper or a mechanical flag, which a store clerk can use to locate a store shelf.

The shelf label 220 is preferably inserted securely in the shelf label holder 200. The shelf label 220 may be easily printed by the store clerk and is preferably made of paper but may be plastic or another suitable material. Further, on the shelf label 220 may be printed information such as a description or price of corresponding merchandise. In addition, the shelf label 220 may have a unique, identifying section including, for example, a unique bar code, radio frequency identification (RFID) tag, or magnetic identification tag. The identifying section (e.g., a bar code) may be printed on one end and may be used for automatically verifying that the shelf label 220 is inserted into the correct shelf control unit 210 as specified by the store's planogram, data regarding which has been transmitted from the host controller 120 to the shelf control unit 210 and stored in memory.

The illuminating section 230 may include, for example, one or more light-emitting diodes, organic light emitting diodes, liquid crystal display elements, plasma display elements, incandescent light bulbs or light pipes, or any combination thereof. The illuminating section 230 may also be powered by conventional power sources such as the store's AC power supply, small batteries, solar power or other means. The illuminating section 230 may further include, for example, a series of light bulbs, diodes and so forth, or a light strip along the top or bottom edge of the shelf label holder 200. Such an illuminating section 230 may further be subdivided into sections, each corresponding to a portion of the shelf and, therefore, the corresponding item of merchandise for that shelf. These subdivisions in the illuminating section 230 may be lit individually under the control of the shelf control unit 210.

For example, is Brand X corn is to be restocked and the clerk inputs this information into the host controller 120, the host controller 120 may then transmit this information to the corresponding shelf control unit 210 for Brand X corn. The shelf control unit 210 will not cause the its entire illuminating section 230 to light up, just the portion of the illuminating section 230 corresponding to Brand X corn. In this way, the clerk knows the exact shelf location for restocking Brand X corn.

The shelf control unit 210 may also have a scanning section 212 into which is inserted the identifying section (e.g., the bar coded end) of the shelf label 220. In addition, the shelf control unit 210 may contain a simple processor and a memory device for storing planogram data such as, for example, portions of planogram data pertaining to that particular shelf label holder 200 (i.e., not all of the planogram data needs to be stored in the shelf control unit 210, only the data pertaining to that particular shelf), and a shelf identification. The memory device may also store merchandise data for the merchandise corresponding to that particular shelf. Such merchandise data may include, for example, pricing information and inventory information (e.g., how much of that particular merchandise is on the shelf and how much is in the total store inventory).

The host controller 120 may direct all of the restocking and repricing activities for the store. The host controller 120 may include, for example, a keypad or other device (e.g. a bar code scanner) for inputting information into the system 100. A store clerk can use such an input device to input data such as, for example, the store's planogram data (e.g., the correct shelf location for each item of merchandise in the store's inventory) and merchandise data (e.g., merchandise pricing and inventory information) into the system 100. The host controller 120 may also include a processor for processing data and other information necessary to control the inventive system 100. The host controller may also contain a memory device 121 for storing merchandise data such as inventory quantities, dates, vendors and vendor information such as phone numbers and email addresses, and planogram data such as the correct shelf location for a particular merchandise. The host controller may 120 may further include a display device (e.g., a video display) for visually displaying information that is input or output by the host controller 120. The display 131 may include, for example, a liquid crystal display or light emitting diode (LED) display. The host controller 120 may also include a transceiver 125 for wirelessly transmitting and receiving signals from the shelf control unit 200 and the hand held device 130. For example, once planogram data is input into the store's host controller 120, the host controller 120 may use the transceiver to transmit planogram data and merchandise data to the various shelf control units 210 throughout the store.

The hand-held unit 130 may be, for example, a Palm Pilot or other personal data assistant (PDA) device which is compact and portable. The hand held unit 130 may be powered by batteries, solar power or other power supply appropriate for such a portable unit. The hand-held unit 130 may also have a memory 140 for storing merchandise data (e.g., price, amounts in stock, dates stocked) and planogram data (e.g., shelf location, row location, etc.). Although it would not be necessary to store planogram data in the hand held unit in most cases because this information is stored in the host controller 120 and may be transmitted to the hand held unit 130 as needed. The hand held unit 130 may further include a display 131 (e.g., a video display) for conveying information to the clerk regarding such information. The display 131 may include, for example, a liquid crystal display or light emitting diode (LED) display. In addition, the hand held unit 130 may include a bar code scanner 135 for scanning a bar code on a merchandise item and inputting information regarding the merchandise into the inventive system 100. The hand held unit 130 may also include a keypad for inputting data into the system 100 using the hand held unit 130. The hand held unit 130 may further include a portable printer 145 which is capable of printing a shelf label 220 predetermined size (e.g., a four foot long) at the direction of the clerk.

For example, a clerk may use the keypad on the host controller 120 to input into the host controller 120 planogram data which identifies shelf 12 in aisle 3 as containing, for example, Brand X corn and Brand X peas, and merchandise data such as, for example, the price of a can of Brand X corn or the amount of Brand X peas to be stocked on the shelf. The host controller 120 may transmit this information to the shelf control unit 210 on the shelf label holder 200 for shelf 12 in aisle 3. The shelf control unit 210 stores this data in its memory so that it now “knows” that the shelf contains Brand X corn and Brand X peas. Specifically, the data may include bar code data or other data regarding Brand X corn and Brand X peas so that if, for example, a store clerk would use a hand held unit 130 to scan a bar code on a can of Brand X corn, the shelf control unit 120 on shelf 12 in aisle 3 may be caused to light up so that the clerk would know where to locate Brand X corn.

The host controller 120 may also be used to transmit data to the hand held unit 130. For example, while the hand held unit 130 is being carried by a first clerk who is performing restocking, a second clerk may be inspecting the inventory in the host controller's database or physically inspecting the inventory in the back of the store. If, for example, the second clerk sees that Brand X peas needs to be repriced, the clerk may input this data into the host controller 120 (e.g., by scanning a can of Brand X peas, or using a keypad) and the host controller 120 may transmit this data to the hand held unit 130 which is being carried by the first store clerk. The display device on the hand held unit 130 may then list the items to be restocked (e.g., that Brand X peas need to be restocked) or repriced as that information is input into the host controller 120 by the first store clerk. The second store clerk may view this list on the display of the hand held unit 130 and perform restock Brand X peas accordingly. Further, once the second clerk has restocked Brand X peas, the clerk may input this information into the hand held unit, for example, by using the keypad on the hand held unit or by scanning a can of Brand X peas. This would cause Brand X peas to be removed from the list of merchandise to be restocked or repriced on the display device of the hand held unit, so that the first clerk may then repeat the procedure for the next item of merchandise on the list.

In addition to the aforementioned features, the host controller 120, shelf control unit 210 and hand-held unit 130 may include transceivers 125, 211 and 135, respectively, for transmitting and receiving signals to and from the other devices in the inventive system 100. Such transceivers may utilize, for example, radio signals, infrared signals or other wireless communication signals.

Using transceivers 211, 125 and 135, the inventive system 100 allows the host controller 120, shelf control unit 210 and hand held unit 130 to wirelessly exchange information. For example, when a clerk uses the hand held unit 130 to scan the bar code of a particular item of merchandise, the hand held unit 130 may transmit a signal to the shelf control units 210. The shelf control units 210 in the store may receive the signals transmitted from the hand held unit 130 and when the corresponding shelf control unit 210 detects its identifying signal, that corresponding shelf control unit 210 may cause its illuminating section 230 to light up accordingly so that the clerk can visually identify the correct shelf location for that particular merchandise.

Alternatively, the hand held unit may be used to transmit a signal to the host controller 120. This may be useful, for example, to notify the host controller 120 that the clerk has restocked or repriced the scanned merchandise. The host controller 120 may use this information, for example, to adjust its inventory database. For example, if the database indicates that an inventory of a particular item of merchandise is low, the host controller 120 may indicate this on the display device contained within the host controller so that a clerk may see this information and order more of that particular merchandise. Alternatively, the host controller 120 may be programmed to automatically transmit a purchase order to the vendor of that particular merchandise, for example, by placing a telephone order or an email order.

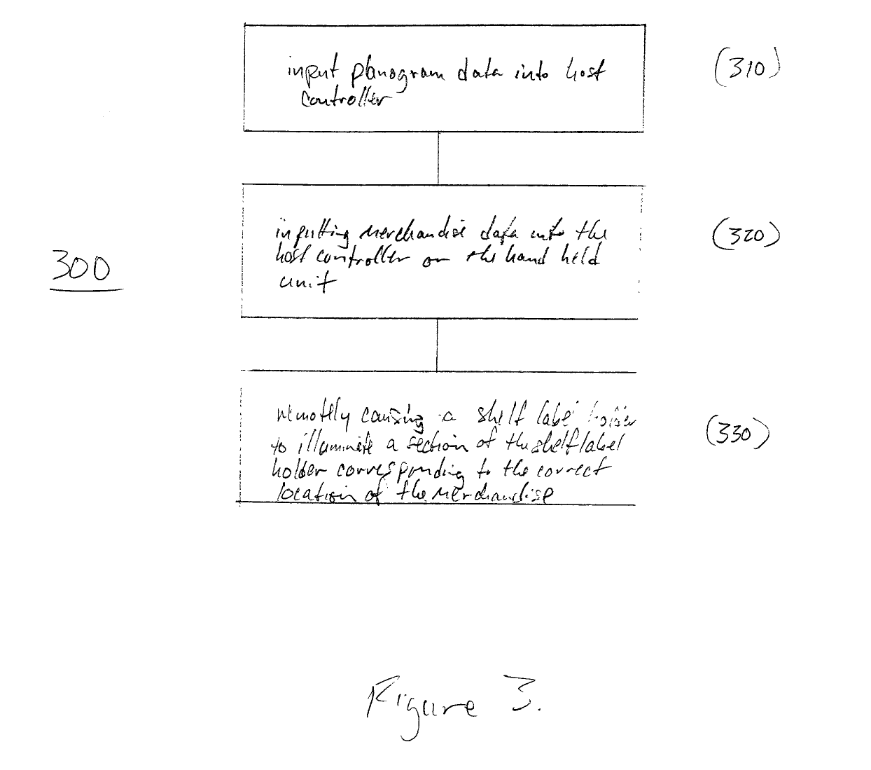

Generally, the inventive system 100 may be utilized by a stock/price clerk who is engaged in any task which requires knowledge of the store's inventory or the correct shelf location of a particular merchandise. For example, FIG. 3 shows a flow diagram illustrating a method 300 of restocking and repricing merchandise according to the present invention.

As shown in FIG. 3, the inventive method 300 uses a system having a host controller, shelf label holder and hand held unit. The inventive method 300 includes inputting (310) planogram data into the host controller. As noted above, this may be done, for example, by scanning a bar code on an item of merchandise or by using a keypad. Further, this step may be monitored by viewing a display device on the host controller.

The inventive method 300 further includes inputting (320) merchandise data regarding the merchandise to be restocked or repriced into the hand held unit or the host controller. As explained above, such merchandise data may include, for example, inventory data or pricing data. For example, a clerk may use the hand held unit to scan an item of merchandise to be repriced. Alternatively, the clerk may, for example, use the keypad on the hand held unit to input this data.

The inventive method 300 also includes remotely causing (330) a shelf label holder to illuminate a section of the shelf label holder corresponding to the correct location of the merchandise. As explained above, either the host controller or the hand held unit may wirelessly transmit a signal (e.g., a radio signal) to the shelf label holder where the merchandise is located. The shelf control unit of that shelf label holder may then illuminate the corresponding section of shelf for that particular merchandise.

For example, as specifically applied to a restocking scenario, data regarding the merchandise to be restocked may be input into the hand-held unit 130. The data may also be input into the host controller 120 which may then transmit a signal to the hand held unit. The clerk may then view the display on the hand held unit which lists the merchandise to be restocked. The clerk may then retrieve the merchandise from inventory and scan the bar code on the merchandise with the bar code scanner 135 on the hand held unit 130. The hand held unit may then transmit a signal which causes the shelf label holder to illuminate the section of the shelf label holder corresponding to the merchandise. The display device 145 may also display the shelf location which the clerk may use, in addition to the illuminated shelf label holder, to locate the correct location for the merchandise to be restocked. Alternatively, the shelf control unit 210 may be programmed so as to illuminate the illuminating section 230 only when the hand-held unit 130 is within a predetermined distance of the correct shelf location.

As noted above, when the transceiver 211 of the shelf control unit 210 detects its unique signal, the shelf control unit 210 causes the illuminating section 230 corresponding to the scanned merchandise to illuminate. In addition, only the portion of the illuminating section 230 corresponding to the merchandise may be caused to illuminate by the shelf control unit 210. The clerk may then search the store for the lighted shelf label holder 200 and once located, restock the merchandise on the shelf above the lighted shelf label holder 200 accordingly.

Also as noted above, after restocking the merchandise, the clerk may use the bar code scanner 135 or the keypad on the hand-held unit 130 to scan the bar code on the merchandise and its corresponding bar code on the shelf label 220. The hand-held unit 130 may then transmit a signal to the shelf control unit 210 causing it to deactivate the illuminating section of the shelf label holder 200. The hand-held unit 130 may also transmit a signal to the host controller 120 to indicate that the restocking operation has been completed.

As explained above, the inventive method may also be used to effectively reprice merchandise. Here, as explained in the restocking scenario, each shelf control unit 210 may be “listening” for its unique identification code to be transmitted from the host controller 120 or a hand-held unit 130. When the data regarding merchandise is input (320) into the hand-held unit or the host controller, a signal identifying the corresponding shelf location may be transmitted by the host controller or hand held unit to the shelf label holder 200, remotely causing (320) the shelf control unit 210 of the corresponding shelf label holder 200 to illuminate the corresponding portion of the illuminating section 230. Alternatively, the shelf control unit 210 may not direct the illuminating section 230 to illuminate until the hand-held unit 130 is within a predetermined distance. The illumination indicates to the price clerk where the new shelf label 220 with the new pricing information is to be placed.

If the price clerk has a hand-held unit 130 which includes a portable printer 145, the clerk may then direct the hand-held unit 130 to print the appropriate shelf label 220. The location of the item of merchandise on the printed label may be stored in the memory 131 of the hand-held unit 130. Alternatively, if the planogram data is not stored in the hand-held unit 130, the clerk may retrieve this information as needed from the host controller 120 by using the hand-held unit 130.

The price clerk may then insert the new shelf label 200 into the shelf label holder 200, so that the bar coded end of the shelf label 220 is inserted into the shelf control unit 210. The shelf control unit 210 verifies that the shelf label 220 is in the correct location by reading the bar code on the shelf label 220. The shelf control unit 210 may also transmit a signal to the hand-held unit 130 and the host controller 120 to confirm that the proper shelf label 220 has been inserted into the shelf label holder 200. The host controller 120 may also instruct the shelf control unit 210 to perform this verification at specific time. Alternatively, rather than the shelf control unit 210 reading the bar code, the price clerk could use the keypad on the hand held unit 130 or use the scanner 135 on the hand-held unit 130 to scan the bar code on the shelf label 220 prior to inserting it into the shelf label holder 200. The hand-held unit 130 may then transmit a signal to the host controller 120. Once the host controller 120 receives this information from either the shelf control unit 210 or the hand-held unit 130, the host controller 120 may adjust its inventory database accordingly. The hand-held unit 130 may then direct the price clerk to move to the next shelf that requires a price update.

In addition to the above-referenced restocking and repricing examples, the inventive system and method may also be expanded to use sensors to provide automatic notification when restocking is needed. For example, the shelf 115 may contain “intelligent” features including strain gauges or other weight sensing devices affixed to the surface of the shelf. These devices would transmit a signal to the shelf control unit 210 to alert the system that a particular item of merchandise is low or non-existent on the shelf 115. The shelf control unit 210 may then transmit a signal to the host controller 120 which would automatically transmit a signal to the hand-held unit 130 of the stock clerk, prompting the clerk to restock that item of merchandise.

Further, the inventive system and method may provide additional applications for customers who are shopping in the store. For example, the customer may be issued by the store a personal hand-held unit 130 which may be, for example, attached to shopping carts or hand baskets. The customer may then input the merchandise which is sought into the hand-held unit 130 which would transmit a signal to the corresponding shelf control unit 210 which would direct the illuminating section 230 to light up under the merchandise sought by the customer. This would be effective in not only increasing a shopper's efficiency, but also reduce the number of customer service personnel required to direct customers to appropriate aisles.

In addition, while the above scenarios have employed a bar code scanner for use with a bar code (i.e., a Universal Price Code (UPC) of the like) other identification system could be employed such as radio frequency identification (RFID) tags and the like. Further, it should be understood that “scanning merchandise” as discussed herein, means scanning such a bar code or other identification tag on such merchandise.

With its unique and novel features, the inventive system and method reduces the search time for stock/price clerks who are tasked with repricing or restocking merchandise and provides improved accuracy in repricing or restocking. Therefore, the invention results in considerable cost savings. Moreover, the invention itself is inexpensive, employing a mix of inexpensive traditional devices (e.g., a paper label) with modern technology.

While the invention has been described in terms of preferred embodiments, those skilled in the art will recognize that the invention can be practiced with modification within the spirit and scope of the appended claims.

What we claim is:

1. A system for restocking and repricing merchandise, comprising:
a shelf label holder having an illuminating function; and
a hand-held unit which remotely causes said shelf label holder to illuminate under a predetermined condition.

2. The system according to claim 1, further comprising:
a host controller for storing merchandise data and planogram data, processing said data and remotely controlling an operation of said hand-held unit and said shelf label holder.

3. The system according to claim 2, wherein said shelf label holder comprises:
a shelf control unit for controlling an illumination of said shelf label holder; and
an illuminating section for illuminating as directed by said shelf control unit.

4. The system according to claim 3, wherein an identifying section of said shelf label is inserted into said shelf control unit.

5. The system according to claim 4, wherein said shelf control unit comprises:
a receptacle for receiving said identifying section of said shelf label; and
a transceiver for transmitting signals to said host controller and said hand held unit and receiving signals from said host controller and said hand held unit.

6. The system according to claim 3, wherein said hand held unit comprises:
a transceiver for transmitting signals to said host controller and said shelf control unit and receiving signals from said host controller and said shelf control unit;
a display device for displaying merchandise data and planogram data;
at least one of a bar code scanner and a keypad for inputting said data into said hand held unit; and
a memory for storing said data.

7. The system according to claim 3, wherein said host controller comprises:
a memory for storing planogram data and merchandise data;
a display device for displaying said data;
at least one of a bar code scanner and a keypad for inputting said data; and
a transceiver for transmitting signals to said shelf control unit and said hand held unit and receiving signals from said shelf control unit and said hand held unit.

8. The system according to claim 7, wherein said merchandise information comprises vendor information data, pricing data and inventory data, and wherein said planogram data comprises correct merchandise shelf locations.

9. The system according to claim 2, wherein said host controller transmits planogram data and merchandise data to said hand held unit and said hand held unit displays said data.

10. The system according to claim 4, wherein said identifying section comprises at least one of a bar code, a radio frequency identification (RFID) tag and a magnetic identification tag.

11. The system according to claim 3, wherein said illuminating section comprises at least one of a light-emitting diode, an organic light emitting diode, a liquid crystal display element, a plasma display element, an incandescent light bulb and a light pipe.

12. The system according to claim 5, wherein said signals comprise at least one of a radiowave signal and infrared signal.

13. The system according to claim 2, wherein said merchandise data comprises merchandise restocking and repricing information.

14. A system for restocking and repricing merchandise, comprising:
a host controller;
a shelf label holder comprising:
a shelf control unit for controlling an operation of said shelf label holder, said shelf control unit comprising:
a memory device for storing data;
a receptacle for receiving an identifying section of a shelf label; and
a transceiver for transmitting and receiving signals; and
an illuminating section for illuminating under direction of said shelf control unit; and
a hand-held unit comprising:
a memory device for storing data;
at least one of a display device and a bar code scanner for inputting data; and
a transceiver for transmitting and receiving signals
wherein said host controller, comprises:
a memory for storing data;
a processor for processing data;
at least one of a display device and a bar code scanner for inputting data; and
a transceiver for transmitting and receiving signals,
wherein said host controller remotely prompts said hand-held unit to display data, and
wherein said host controller and said hand-held unit remotely control said shelf control unit.

15. The system according to claim 14,
wherein said shelf control unit transmits a signal to said handheld unit and said host controller, and receives a signal from said hand held unit and said host controller,
wherein said hand-held unit transmits a signal to said shelf control unit and said host controller, and receives a signal from said shelf control unit and said host controller, and
wherein said host controller transmits a signal to said shelf control unit and said hand held unit, and receives a signal from said shelf control unit and said hand held unit.

16. A method for restocking and repricing merchandise using a system having a shelf label holder, a hand held unit and a host controller, said method comprising:
inputting planogram data into said host controller;
inputting merchandise data into one of said hand held unit and said host controller; and
remotely causing said shelf label holder to illuminate a section of said shelf label holder corresponding to a correct location for said merchandise.

17. The method according to claim 16, wherein said merchandise data comprises one of restocking data and repricing data.

18. The method according to claim 16, further comprising:
storing said planogram data and said merchandise data in said host controller; and
storing said merchandise data in said hand held unit and said shelf label holder.

19. The method according to claim 16, wherein said merchandise data is input into one of said host controller and said hand held unit using one of a keypad and a bar code scanner.

20. A programmable storage medium tangibly embodying a program of machine-readable instructions executable by a digital processing apparatus to perform a method for at least restocking and repricing merchandise using a system having a shelf label holder, a hand held unit and a host controller, said method comprising:
inputting planogram data into said host controller;
inputting merchandise data into one of said hand held unit and said host controller; and
remotely causing said shelf label holder to illuminate a section of said shelf label holder corresponding to a correct location for said merchandise.
